(19) United States
(12) Patent Application Publication
(10) Pub. No.: US 2012/0073379 A1
(43) Pub. Date: Mar. 29, 2012

(54) Sensor system for detecting high pressures

(76) Inventors: Marcus Ahles, Pfullingen (DE); Hubert Benzel, Pliezhausen (DE)

(21) Appl. No.: 13/138,674

(22) PCT Filed: Feb. 1, 2010
(86) PCT No.: PCT/EP2010/051138

§ 371 Date: Dec. 8, 2011

(30) Foreign Application Priority Data
Mar. 31, 2009 (DE) 10 2009 002 004.7

(51) Int. Cl. G01L 7/08

(52) U.S. Cl. 73/715

(57) ABSTRACT

A sensor system for detecting high pressures includes a micromechanical sensor element which is situated on a support and is mounted via this support. A diaphragm is formed in the upper surface of the sensor element, the diaphragm spanning a cavern having a rear opening. The support has a passage opening and is connected to the rear side of the sensor element in such a way that the passage opening opens into the rear opening of the cavern. An annular recess is formed in the rear side of the sensor element, the annular recess being situated above the edge area of the passage opening, so that the joining surface between the sensor element and the support does not extend to the edge of the passage opening.

### BACKGROUND OF THE INVENTION

1. Field of the Invention

The present invention relates to a sensor system for detecting high pressures having a micromechanical sensor element which is situated on a support and is mounted via this support, for example, on a metal base or in a housing. A diaphragm is formed in the upper surface of the sensor element, the diaphragm spanning a cavern having a rear opening. The support has a passage opening and is connected to the rear side of the sensor element in such a way that the passage opening opens into the rear opening of the cavern.

2. Description of Related Art

A sensor system of this type having a silicon chip as a sensor element is described in published German patent application DE 10 2004 006 199 A1. A diaphragm is formed in the chip upper surface into which the piezoresistors for signal detection are integrated. The diaphragm was formed in this case by etching the rear side of the chip substrate. Accordingly, the diameter of the rear opening of the cavern thus formed under the diaphragm is at least as large as the diaphragm diameter. The sensor element was then bonded to a glass support having a metalized rear side so that the glass support including the sensor element may be soldered to a metal support. In this design, the glass support is used for reducing the mechanical stress arising during assembly and acting on the sensor element. In this case, pressure is applied to the sensor diaphragm via a passage opening in the glass support which opens into the cavern under the diaphragm. This passage opening is normally produced in the glass support by ultrasound boring, laser treatment, sandblasting or heat treatment using stamping. This results in microdefects in the side walls of the passage opening while the upper surface of the glass support is largely free from such defects.

In particular when detecting high pressures, the entire structure of the known sensor system is exposed to particular stresses which may even result in a fracture in the sensor system in overload situations. In this connection, the fact that the resistance to fracture of silicon is greater than that of glass plays a significant role.

BRIEF SUMMARY OF THE INVENTION

The present invention provides a simple and cost-effective design having high overload resistance for a sensor system of the type referred to at the outset.

To that end, according to the present invention, an annular recess is formed in the rear side of the sensor element, the annular recess being situated above the edge area of the passage opening of the support, so that the joining surface between the sensor element and the support does not extend to the edge of the passage opening.

The annular recesses may be designed to be round, rectangular or square, preferably adapted to the shape of the diaphragm. In this connection, the shape of the passage opening in the support is independent of this.

According to the present invention, it has initially been found that a maximum mechanical stress which is proportional to the pressure to be measured occurs within the glass support at the location where the silicon substrate comes into contact with the glass surface. Depending on whether the rear opening in the silicon substrate is larger or smaller than the passage opening in the glass support, this maximum stress thus lies either in an area beneath the defect-free glass surface or in the edge area of the passage opening, the walls of which have microdefects. In the burst case, cracks initially form in the glass at the site of the maximum stress just beneath the silicon-glass joint, which may ultimately result in a fracture in the joint area. It has further been found that sensor systems whose maximum mechanical stress lies in the area beneath the defect-free glass surface have a significantly higher burst pressure than sensor systems in which the maximum mechanical stress lies in proximity to the microdefective walls of the passage opening, since cracks are preferably formed or grow in this area in the loading case.

Based on this, it is proposed according to the present invention to shift the maximum mechanical stress between the sensor element and support in a targeted manner into an area which is as free from defects as possible by a suitable layout of the rear side of the sensor element, namely independently of the shape and size of the sensor diaphragm. As is advantageous for detecting high pressures, the sensor diaphragm may be relatively small, even if the passage opening in the support is larger than the diaphragm. That is to say, the passage opening should not be smaller than a minimum size, since particles, dirt or other media may collect and lodge in excessively small bores, which adversely affects the function of the sensor system.

Advantageously, the implementation of the measures according to the present invention requires only a simple modification of the standard production process of the sensor elements. This does not affect either the support and the housing or the mounting surface.

As already mentioned, the diaphragm surface for measurements in higher pressure ranges should be relatively small. Since the diaphragm size is independent of the size of the passage opening due to the recess formed in the rear side of the sensor element according to the present invention, the diaphragm surface may also be smaller than the cross-sectional area of the passage opening, the shape of the diaphragm being of any desired size. Thus the diaphragm may be round or even angular, for example, rectangular or square. For a further reduction of the sensitivity, the diaphragm may also be designed in the shape of a ring as a boss diaphragm. The particular advantage of this is that circuit components may be situated in the stiffened center area of such an annular diaphragm in order to keep the chip surface as small as possible.

In an advantageous embodiment of the sensor system according to the present invention, the annular recess in the rear side of the sensor element merges into the rear opening of the cavern. In this case, an adjustment offset between the sensor element and the support may be compensated in a simple manner with the aid of the circumferential recess.

If the diaphragm is very small compared to the passage opening in the support, the circumferential recess in the rear side of the sensor element may also be formed to be at a distance from the rear opening of the cavern.

In a particularly advantageous variant of the sensor system according to the present invention, a groove is formed in the outer edge area of the annular recess in the rear side of the sensor element. This makes the edge area of the recess resting on the support slightly elastic, which results in a better distribution of the mechanical stress acting on the joint between the sensor element and the support.

### BRIEF DESCRIPTION OF THE DRAWINGS

FIG. 1 shows a schematic cross section of a first sensor system 10 according to the present invention.

FIG. 2 shows a schematic cross section of a second sensor system 20 according to the present invention.

FIG. 3 shows a schematic cross section of a third sensor system 30 according to the present invention.

FIGS. 4a through 4d illustrate a first method variant for manufacturing sensor system 10 represented in FIG. 1 based on schematic cross-sectional representations.

FIGS. 5a through 5d illustrate a second method variant for manufacturing sensor system 10 represented in FIG. 1 based on schematic cross-sectional representations.

### DETAILED DESCRIPTION OF THE INVENTION

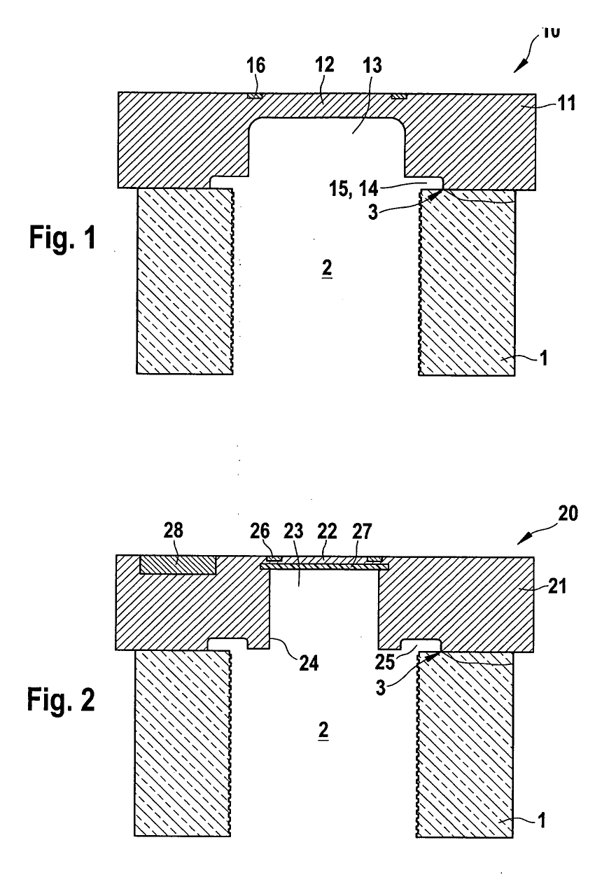

Sensor system 10 represented in FIG. 1 is used for detecting high pressures. To that end, sensor system 10 includes a micromechanical sensor element 11 which is situated on a support 1 having a passage opening 2. Sensor element 11 is mounted, for example, in a housing or on a mounting base via support 1, support 1 being used for reducing the occurring mechanical stresses.

Sensor element 11 is a silicon chip, a diaphragm 12 being formed in its upper surface having piezoresistive transducer elements 16 for signal detection. However, sensor element 11 may also be made from another semiconductor material. Diaphragm 12 spans a cavern 13 which is produced by trench etching of the chip's rear surface.

Support 1 is a glass support 1 having a smooth, defect-free upper surface which is largely free from microdefects. Passage opening 2 in glass support 1 is implemented in the form of a bore 2. Accordingly, the walls of passage opening 2 are rough and have micro-cracks. Sensor element 11 is situated on glass support 1 in such a way that bore 2 opens into rear opening 14 of cavern 13. The joint between sensor element 11 and glass support 1 is produced by anodic bonding.

Since the resistance to fracture of glass is lower than that of silicon, a maximum mechanical stress occurs at the location in the glass support where the silicon surface comes into contact with the glass support. The weak point of sensor system 10 described here is thus in the area of glass support 1, which borders the edge of the joining surface between silicon chip 11 and glass support 1.

In the exemplary embodiment represented here, the diaphragm diameter is smaller than the diameter of bore 2. To prevent the joining surface between silicon chip 11 and glass support 1 from extending to the edge of bore 2, an annular recess 15 was produced in the rear side of the chip which is situated above the edge area of bore 2. In this case, recess 15 represents a superficial widening of rear opening 14 of cavern 13, since recess 15 merges into cavern 13. With the aid of annular recess 15, maximum mechanical stress 3 was shifted from the fracture-critical edge area of bore 2 into an area beneath the microdefect-free upper surface of the support. Since the static and dynamic strength of the glass is substantially better in the area of the smooth surface than in the area of the bore having microcracks, the burst pressure of sensor system 10 presented here is comparatively high.

Sensor elements having a relatively smaller sensor diaphragm and relatively greater diaphragm thickness are usually used for measuring higher pressures. For that reason, the sensor diaphragm of these sensor elements is frequently significantly smaller than the passage opening in the support. It is not possible to reduce the size of this opening as desired because too narrow passage openings become plugged easily, resulting in impairment of the sensor function.

FIG. 2 shows a sensor system 20 having a particularly small sensor diaphragm 22, which was produced using a trench process on the rear and a stop layer 27 buried in the silicon of sensor element 21. Stop layer 27 may be made, for example, from an oxide layer which has been introduced over the entire surface or also structured into a silicon wafer. After diaphragm 22 is exposed, stop layer 27 may be optionally removed, for example by a wet chemical etching process or a dry etching process; an HF vapor or gas phase etching step is also possible. Piezoresistors 26 are integrated into diaphragm 22 for signal detection, and components of an evaluation circuit 28 are situated to the side of diaphragm 22.

As in the case of sensor system 10, sensor element 21 is also bonded to a polished glass support 1 having a passage bore 2, so that bore 2 opens into cavern 23 beneath sensor diaphragm 22. According to the present invention, an annular recess 25 is formed in the rear side of sensor element 21, the annular recess being situated concentrically and in this case at a distance from rear opening 24 of cavern 23 across the edge area of passage opening 2, so that the joining surface between sensor element 21 and support 1 does not extend to the edge of passage opening 2 and maximum stress 3 lies in an area beneath the smooth upper surface of the support. The width of recess 25 was selected according to the manufacturing and adjustment tolerances in the joint of silicon chip 21 and glass support 1.

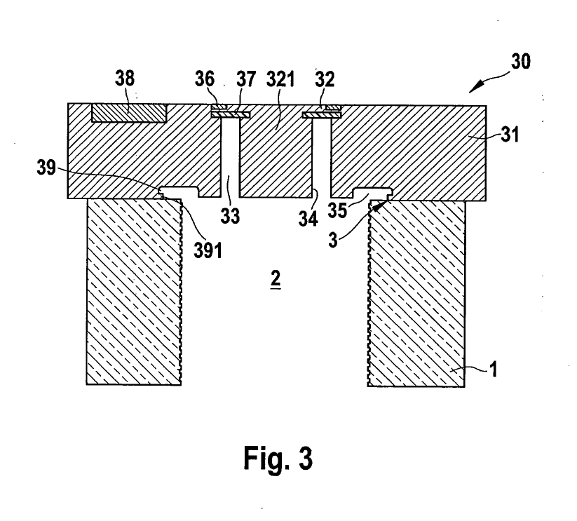

A sensor system 30 having an annular diaphragm 32 which is also referred to as a boss diaphragm is represented in FIG. 3. Such annular diaphragms have comparatively low sensitivity and relatively high diaphragm burst pressure and are therefore suitable in particular for detecting high pressures. Piezoresistors 36 for detecting the diaphragm deflection are also integrated into the outer edge area of annular diaphragm 32 in this case. Components of an evaluation circuit 38 are situated to the side of the diaphragm structure. At this point, it should be noted that it is also possible to position circuit components in stiffened center area 321 of the diaphragm structure to reduce the chip surface necessary for the sensor element.

Annular diaphragm 32 was also exposed with the aid of a rear trench process and a stop layer 37 buried in the silicon of sensor element 31, thereby creating an annular cavern 33 having an annular rear opening 34 beneath annular diaphragm 32. In addition, an annular recess 35 was formed in the rear side of sensor element 31 which is situated concentrically and in this case at a distance from rear opening 34 of cavern 33. In addition to round annular structures, rectangular or square structures are also possible using the trench process.

As in the cases of sensor systems 10 and 20, sensor element 31 is also bonded to a polished glass support 1 having a passage bore 2, so that bore 2 opens into annular cavern 33 beneath annular diaphragm 32. Annular recess 35 was positioned above the edge area of passage opening 2, so that the joining surface between sensor element 31 and support 1 does not extend to the edge of passage opening 2, and maximum stress 3 lies in an area beneath the smooth upper surface of the support.

Annular recess 35 in the rear side of sensor element 31 was in this case produced in a two-stage trench step to form a groove 39 in the outer edge area of annular recess 35. This groove 39 or adjacent elastic lip 391 in the rear side of the chip also contributes to reducing stress in glass support 1, which increases the bursting strength of sensor system 30 overall.

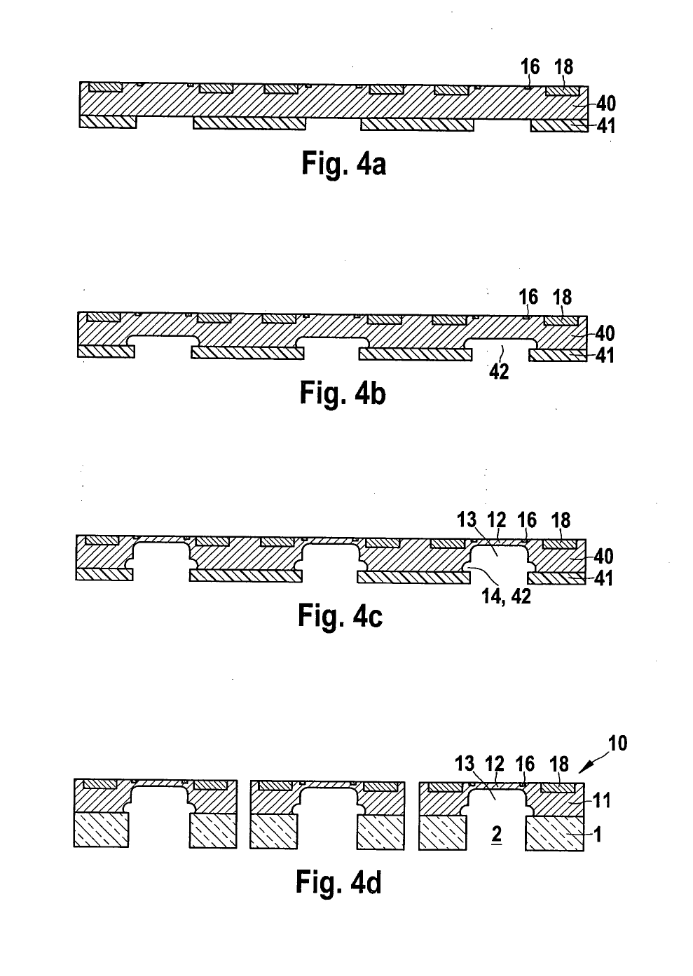

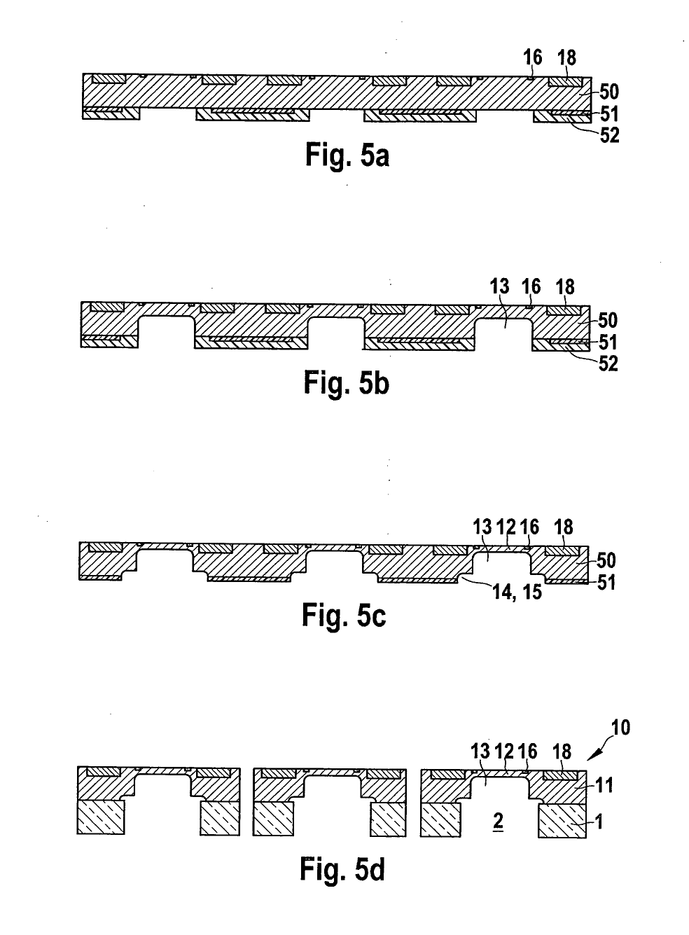

Various possibilities exist for manufacturing a sensor element as has been described in connection with FIGS. 1, 2 and 3. Two in particular advantageous method variants, specifically a one-mask process based on FIGS. 4a through 4d and a two-mask process based on FIGS. 5a through 5d, are described in the following.

In both cases, circuit elements such as, for example, piezoresistors 16 for signal detection and circuit components 18 for signal processing and signal evaluation are initially produced on the front side of a silicon wafer 40 and 50.

In the case of the one-mask process, the cavern beneath the sensor diaphragm and also the annular recess according to the present invention are produced with the aid of a single mask which is applied to the rear side of the wafer. The mask may be, for example, a varnish mask or also an oxide mask. FIG. 4a shows a section from a silicon wafer 40, piezoresistors 16 and circuit components 18 of three sensor elements being integrated into its upper surface and its rear side being provided with an appropriate mask layer 41.

Wide recesses 42 are produced in a first isotropic etching step, in which the etching is carried out not only into the depth but also in the lateral direction, mask 41 being undercut. The result of this etching step is represented in FIG. 4b.

Sensor diaphragms 12 are exposed by trenching in a second etching step. The trench process is a sequence of isotropic plasma etching using SF₆ alternating with side wall passivation, so that material is removed only in the depth and not in a lateral direction. The trench process begins in this case with a passivation step in which the walls of wide recesses 42 are passivated. The ion bombardment in the subsequent etching step initially removes the passivation on the bottom of recesses 42 again and then etches further into the depth. The passivation on the side walls of recess 42 is preserved. The trench process is continued until the desired diaphragm thickness is achieved. To that end, the trench process may, for example, be limited in time by an in situ depth measurement or also by a stop layer within the wafer. FIG. 4c shows silicon wafer 40 after the completion of the trench process, in which caverns 13 have been created beneath sensor diaphragms 12. Recesses 42 form a widening of rear openings 14 of these caverns 13. In each case, the edge area of a recess 42 represents an annular recess in the rear side of a sensor element, which in this case merges into cavern 13 beneath sensor diaphragm 12.

Subsequently, mask layer 41 is removed before silicon wafer 40 including its structured rear side is bonded to a polished glass support 1 having passage bores 2. Passage bores 2 are situated in such a way that each of them opens into a cavern 13 beneath a sensor diaphragm 12 and annular recesses 42 in the rear side of the wafer are each situated above the edge area of a passage bore 2. Only after the bonding process are sensor elements 11 separated, for example, by sawing, glass support 1 also being cut off. FIG. 4d shows sensor systems 10 after the separation process and before mounting in a housing.

As in the one-mask process, it is also possible to produce a groove in the case of the two-mask process. In the two-stage design of the first etching step of the one-mask process described above, it is also possible to produce a groove in the outer edge area of the annular recess.

In contrast to the method variant described above, a first mask 51 in the form of a structured oxide layer is initially applied to the rear side of silicon wafer 50 in the two-mask process. The size, shape and position of the annular recess according to the present invention in the rear side of the sensor elements are defined using this first mask 51. A second mask 52 is applied to the rear side of silicon wafer 50 which is masked in this manner, the second mask being used for defining the size, shape and position of the caverns and accordingly of the sensor diaphragms as well. This mask may be, for example, a varnish mask. FIG. 5a shows a silicon wafer 50 having a rear side which has such a dual mask. The openings in second mask 52 are in this case smaller than the openings in first mask 51 and are situated within the area of these openings in first mask 51.

In a first trench step, caverns 13 are produced above the openings in second mask 52 in the rear side of the wafer, which is represented in FIG. 5b.

After second mask 52 has been removed, a second trench step is performed above the openings in first mask 51 which have a larger opening cross section than caverns 13. Accordingly, not only caverns 13 are made deeper in this second trench step in order to expose sensor diaphragms 12, but in addition, the surfaces of rear openings 14 of caverns 13 are widened, which is illustrated by FIG. 5c. Each of these widenings of rear openings 14 represents an annular circumferential recess 15 in the rear side of the wafer which merges into a cavern 13 beneath a sensor diaphragm 12.

The two-mask process also makes it possible to produce circumferential recesses 25 and 35 which, as represented in FIG. 2 and FIG. 3, are situated at a distance from rear opening 24 and 34 so that the joining surface between sensor element 21 and 31 and support 1 does not extend to the edge of passage opening 2. To that end, mask 51 is structured in such a way that a ring remains outside of rear opening 24 and 34 and within groove 25 and 35.

As in the one-mask process, silicon wafer 50 including its structured rear side is bonded to a polished glass support 1 having passage bores 2 after first masking layer 51 has also been removed. Passage bores 2 are situated and dimensioned in this case as well in such a way that each of them opens into a cavern 13 beneath a sensor diaphragm 12 and each annular widening 15 of rear openings 14 is situated above the edge area of a passage bore 2. Only after that are sensor elements 11 separated, for example, by sawing, glass support 1 also being cut off. FIG. 5d shows resulting sensor systems 10 before mounting in a housing.

A groove in the outer edge area of the annular recess in the rear side of the chip may in this case be produced simply by modifying the second trench step. In addition, if the design of the first masking layer is appropriate, the two-mask process described above may also be used for producing sensor elements in which the annular recess in the rear side of the chip is at a distance from the rear opening of the cavern.

In conclusion, it may still be pointed out that the structure according to the present invention of the sensor element of the claimed sensor system may alternatively also be produced in an isotropic or anisotropic wet chemical process. Moreover, the present invention is not limited to sensor systems having a piezoresistive transducer principle but instead includes, for example, sensor systems having capacitive, inductive or piezoelectric signal detection.

1-9. (canceled)

10. A sensor system for detecting high pressures, comprising:
a micromechanical sensor element having a diaphragm formed in the upper side of the sensor element, the diaphragm spanning a cavern formed in the sensor element, wherein the cavern has an opening in the lower side of the sensor element; and
a support on which is the sensor element is situated, wherein the support has a passage opening and is connected to the lower side of the sensor element in such a way that the passage opening opens into the opening of the cavern;
wherein an annular recess is formed in the lower side of the sensor element, the annular recess being situated above the edge area of the passage opening so that a joining surface between the sensor element and the support does not extend to the edge of the passage opening, and wherein the annular recess is adapted to the shape of the diaphragm.

11. The sensor system as recited in claim 10, wherein the surface of the diaphragm is smaller than the cross-sectional area of the passage opening.

12. The sensor system as recited in claim 10, wherein the diaphragm is configured in the shape of a ring as a boss diaphragm.

13. The sensor system as recited in claim 12, wherein the center are of the boss diaphragm is stiffened, and circuit components are situated in the stiffened center area of the boss diaphragm.

14. The sensor system as recited in claim 10, wherein the annular recess merges into the cavern in the lower side of the sensor element.

15. The sensor system as recited in claim 10, wherein the annular recess in the lower side of the sensor element is situated at a distance from the opening of the cavern.

16. The sensor system as recited in claim 10, wherein a groove is formed in the lateral outer edge area of the annular recess.

17. The sensor system as recited in claim 11, wherein the sensor element is produced starting from a silicon substrate, the support is a glass support, and the lower side of the sensor element is bonded to the glass support.

18. The sensor system as recited in claim 11, wherein the diaphragm has a round shape.
